(19) United States
(12) Patent Application Publication
(10) Pub. No.: US 2010/0316771 A1
(43) Pub. Date: Dec. 16, 2010

(54) TRIGLYCERIDIC NATURE OIL WITH IMPROVED NUTRITIONAL PROPERTIES AND PROCESS FOR THE PREPARATION THEREOF

(75) Inventors: Raquel Bonati Moraes, Velha (BR); Tatiane Caroline Wehmuth Roth, Gaspar (BR)

Correspondence Address: MAYBACK & HOFFMAN, P.A., 5722 S. FLAMINGO ROAD #232, FORT LAUDERDALE, FL, 33330, US

(73) Assignee: BUNGE ALIMENTOS S/A, Poco Grande, Gaspar-SC (BR)

(21) Appl. No.: 12/446,153

(22) PCT Filed: Jul. 23, 2007
(86) PCT No.: PCT/BR07/00188

§ 371 Date: Apr. 17, 2009

(30) Foreign Application Priority Data
Oct. 19, 2006 (BR) PI0605162-6

(51) Int. Cl. C11B 5/00; A23D 9/007; A23D 9/02; A23L 1/302; A23L 1/303; A23L 1/304

(52) U.S. Cl. 426/73; 426/544; 426/72; 426/74; 426/106

(57) ABSTRACT

This invention refers to a vegetal oil or mixture of oils of two or more types of oils, of vegetal or animal origin, for obtaining a product with food grade with the improvement of nutritional values due to the presentation of low content of fat, preferably the saturated ones, low content of trans isomers, free of cholesterol, in which composition there have been included E Vitamin and Q10 Co-enzyme, to be used in salads as well as in cooking (fried, stews, baked, cooked, etc.). In an additional aspect, the invention refers to the process for preparing vegetal oils or the mixture of oils of two or more types of vegetal and/or mineral origin, containing E vitamin and Q10 coenzyme which provides them with a longer time of useful life.

### CROSS-REFERENCE TO RELATED APPLICATIONS

This application claims the priority, under 35 U.S.C. §119, of Brazilian Patent Application No. PI0605162-6 filed 19 Oct. 2006, and International Application No. PCT/BR2007/000188, filed 23 Jul. 2007, which designated the U.S. and was published in English, the entire disclosures of which are all hereby incorporated herein by reference in their entireties.

### STATEMENT REGARDING FEDERALLY SPONSORED RESEARCH OR DEVELOPMENT

n/a

### FIELD OF THE INVENTION

This invention refers to a vegetal oil or mixture of oils of two or more types of oils, of vegetal or animal origin, for obtaining a product with food grade with the improvement of nutritional values due to the presentation of low content of fat, preferably the saturated ones, low content of trans isomers, free of cholesterol, in which composition there have been included E Vitamin and Q10 Co-enzyme, to be used in salads as well as in cooking (fried, stews, baked, cooked, etc.).

### BACKGROUND OF THE INVENTION

Nowadays the concern with the health has been highly discussed and stimulated, as well as the search to reach a better quality of life, supported by governmental campaigns.

The market of functional food, characterized by the segment of healthiness, offers products, which besides its common nutritional function, functional ingredients in its composition such as vitamins, minerals, fibers, probiotics and others which, together with healthy food and lifestyle, help to maintain the health.

The demand for vegetal oils with special composition has been increasing in the last few years. Thus, the vegetal origin oils have had their commercial value highly increased, due to the presence of special components, which characterize such oils as functional food.

It is known that the oils and/or fats which have relatively high contents of polyunsaturated fatty acids are highly susceptible to oxidation. This lipidic oxidation affects the quality of the oils, decreasing the acceptance by the consumer due to the appearance of a rancid taste, as well as causing loss of nutritional values: decrease of the contents of essential fatty acids and vitamins (omega-3 and omega-6).

One of the factors responsible for oil oxidation is called Singlet Oxygen (¹O₂, oxygen activated state). This molecule is formed by the action of light over chlorophyll present in the oil. The Singlet oxygen acts on the double bond of unsaturated fatty acids starting the oxidation process, responsible for the development of unpleasant odors and tastes, reducing the useful life time of the products or even making the food improper for consumption.

Many studies have been developed with the aim of fulfilling the requirements of the market in what it refers to the care with health, searching for complementary or substitute products, which may provide a healthier diet.

It is known that Q10 Co-enzyme acts on the prevention of oxidation of the LDL cholesterol (low density lipoprotein), “the bad cholesterol”. The oxidation of LDL on the walls of the arteries is one of the steps which lead to the development of atherosclerosis. In the coronary artery diseases, the buildup of the plaques of atherosclerosis in the coronary arteries, results in damage to the heart, caused by myocardium infarct. Besides, the Q10 Co-enzyme has been used for treating hypertension, Parkinson disease as well as some types of cancer, such as breast cancer. It is known that, among others, such co-enzyme has antioxidant properties when associated to a health diet and lifestyle.

It is known that E Vitamin acts on the prevention of atherosclerosis and together with Q10 co-enzyme, has a positive effect on the reduction of cardiovascular diseases.

With the aim of inhibiting or delaying the reaction of lipidic oxidation, common in greasy products, the industry usually employs chemical compounds known as antioxidants.

The document of the patent GB 1418311 describes emulsions of water in oil and oil in water containing an enzymatic system comprising co-enzymes such as nicotinamide-adenine-dinucleotide (NADH₂), nicotinamide-adenine-dinucleotide phosphate (NADPH₂) and alcohol-dehydrogenase enzymes, such as alcohol: NAD oxi-reductase and alcohol: NADP oxi-reductase, with the aim of reducing the so called “off-flavors” (rancid odor and flavor, metallic, oxidated) as well as the better preservation of the emulsion. The antioxidant action is due to functional groups of carboxylic acids and amides present in the structure of these co-enzymes.

The document of the U.S. Pat. No. 6,652,891 presents a pharmaceutical composition, which can be used as a dietetic supplement, comprising a liquid emulsion of the oil in water type for oral administration, and which contains Q10 co-enzyme. The Q10 co-enzyme, also referred to as CoQ10, Q10, Q10 Vitamin, Ubiquinone and Ubidecarenone (2,3-dimethoxi-5-methyl-6-decaprenyl benzoquinone), is a soluble oil natural compound, similar to vitamins, which exists in most of the vegetal and animal mitochondrial cells. It can be chemically represented by the formula:

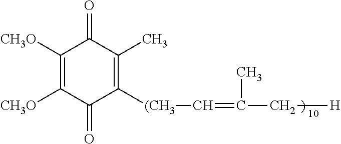

The human organism synthesizes Q10 co-enzyme from amino acids such as tyrosine and a large part of the source of such amino acid comes from meat and fish.

The Q10 co-enzyme is a soluble oil natural compound, similar to vitamins which exist in most of the vegetal and animal mitochondrial cells. Canola oil (1.0 mg/10 g) and soy oil (1.3 mg/10 g) can be mentioned as sources rich in Q10 co-enzyme.

In the context of this invention, the expression Q10 co-enzyme also refers to the terms CoQ10, CoQ, Q1, Q10 vitamin, Ubiquinone, Ubiquinol, Ubisemiquinone, Ubidecarenone, 2,3-dimethoxy-5 methyl-6-decaprenyl benzoquinone and all their forms.

The tocopherols are present in a natural way in most of the vegetal oils, however after a refining process, some of these compounds are lost, even though in a non significant way in nutritional terms. Such loss, however, causes lack of its antioxidative power in the oil. Thus, many times, it has been necessary to add it, after the deodorization stage. The antioxidant activity of the tocopherols is due mainly to the ability of donating their phenolic hydrogens to the free lipidic radicals stopping the propagation of the chain. The tocopherol (alpha, beta, gamma and delta) are referenced herein as E vitamin. Studies confirm that the biological power of the tocopherol as E vitamin decreases according to the sequence: alpha, beta, gamma and delta, and its activity as an antioxidant, increases in the same sequence.

One of the objects of this invention is to provide a food oil with differentiated properties, which provide the consumer with an improvement in the nutritional values as well as a reduced caloric value.

Other object of this invention consists of overcoming at least a part of the shortcomings caused by lipidic oxidation of these components present in oil, which limits to a useful life time smaller than expected and necessary for the market, making them improper for consumption as well as making the food produced by them not acceptable.

### SUMMARY OF THE INVENTION

This invention refers to vegetal oils or the mixture of oils of two or more types of vegetal and/or animal origin, with improved nutritional properties, low content of trans isomers, and from 0.001% to 1% by weight of E vitamin, being also added 0.001% to 5% by weight of Q10 Co-enzyme.

In an additional aspect, the invention refers to the process for preparing vegetal oils or the mixture of oils of two or more types of vegetal and/or animal origin, containing E vitamin and Q10 co-enzyme.

### BRIEF DESCRIPTION OF THE DRAWINGS

Advantages of embodiments of the present invention will be apparent from the following detailed description of the preferred embodiments thereof, which description should be considered in conjunction with the accompanying drawings in which:

FIG. 1 shows a curve relating to the dosage of the peroxide index of Example 1 samples.

FIG. 2 shows a curve relating to the dosage of the Anisidine index of Example 1 samples.

FIG. 3 shows a curve that expresses acidity of Example 1 samples.

FIG. 4 shows the results proven by sensory evaluation of Example 1 samples.

FIG. 5 shows a curve relating to the dosage of the peroxide index of Example 2 samples.

FIG. 6 shows a curve relating to the dosage of the Anisidine index of Example 2 samples.

FIG. 7 shows a curve that expresses acidity of Example 2 samples.

FIG. 8 shows the results proven by sensory evaluation of Example 2 samples.

### DETAILED DESCRIPTION OF THE INVENTION

It was observed that the joint action of the E vitamin associated to Q10 Co-enzyme in oils and fats is very effective to inhibit or delay the reaction of lipidic oxidation, influencing in a positive way the taste of the final product, inhibiting the formation of off-flavors and increasing the useful life time of the food.

In the context of this invention, the terms oil and fat are used in an interchangeable and common way.

Q10 Co-enzyme interacts with E vitamin reducing the free radicals, as is shown on the following reaction mechanism scheme.

Normal Reaction of Lipidic Oxidation:

a) Initiation: the formation of free radicals of fatty acid occurs due to the removal of hydrogen of the allylic carbon in the molecule of the fatty acid, in conditions favored by light and heat:

RH→R.+H.

where RH=unsaturated fatty acid and R.=peroxide radical;

b) Propagation: The free radicals, which are readily susceptible to atmospheric oxygen attack, are converted into other radicals, appearing the primary oxidation products, the peroxides and hydroperoxides. The free radicals formed act as reaction propagators, resulting in an autocatalytic process:

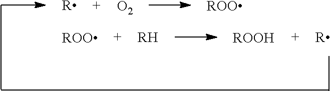

where ROO.=peroxide radical and ROOH=hydroperoxide;

c) Completion: two radicals match, forming stable products (secondary of oxidation) obtained by scission and rearrangement of peroxides (epoxides, volatile and non volatile compounds):

ROO.+R.→ROOR

ROO.+ROO.→ROOR+O₂

R.+R.→RR

where the resulting compounds are stable.

Reaction of lipidic oxidation in the presence of coenzyme and E vitamin:

The interaction of E vitamin with Q10 coenzyme inhibits or delays the reaction of lipidic oxidation, in the following way:

1. Initiation:

RH→R.+H.

Where RH=unsaturated fatty acid and R.=peroxide radical;

2. Propagation: The Propagation stage is interrupted by the action of E vitamin and Q10 coenzyme by reducing the free radicals formed:

R.+O₂→ROO.

ROO.+αTOH→ROOH+αTO.

αTO.+CoQH₂→αTOH+CoQH.

CoQH.+O₂→CoQ+O₂.

CoQH.+αTO.→CoQ+αTOH

where ROO.=peroxide radical; ROOH=hydroperoxide; αTOH=alpha tocopherol; αTO.=alpha tocopheroxyl radical; CoQH₂=Ubiquinol; CoQH=Ubisemiquinone; CoQ=Ubiquinone.

Based on this observation it becomes very promising and advantageous the combined application of such substances in compositions subject to lipidic oxidation, as is the case of oils and fats.

The vegetal oil, according to this invention, is of food grade, comprising one type only or a mixture of two or more types of vegetal and/or animal origin (blend of oils), of any triglyceridic nature, such as: soy or canola or sunflower or corn or rice or grape seed, etc.

Q10 coenzyme is liposoluble and its absorption is significantly improved when ingested with food containing fat. In this case, the inclusion of Q10 coenzyme in vegetal oil or in the mixture of oils of two or more types of vegetal and/or animal origin, presents itself as an excellent vehicle for the ingestion of such component essential to the human organism.

The 10 coenzyme dosage in the vegetal oil or mixture of oils of two or more types of vegetal and/or animal origin (food grade) should guarantee that the final product contains 0.15-1.5% of the antioxidant in amounts not lower than 30 mg/day. In this invention the dosed amount of Q10 coenzyme is in the range of 0.05 to 5.0%. It will be used in the liposoluble way, that is, soluble in oil.

Thus, Q10 coenzyme can be added to the oil, provided it has been previously diluted in a lower amount of oil, in order to promote a better homogenization in the product.

E vitamin and/or mix of tocopherols (comprising alpha, beta, gamma and delta tocopherols), can be added directly to the oil, as besides being liposoluble, they are already provided in oily form.

Optionally the vegetal oils or the mixture of oils of two or more types, being either of vegetal or animal origin, can have the addition of antifoamers, lecithin, dyes/carotenoids and/or mono and diglycerids, according with the applications which they are intended for, as for example, use in salads and cooking, such as fritters, stews, baked, cooking, etc.

The industrial process of refining oils or the mixture of oils of two or more types, being either of vegetal or animal origin, starts with the addition of heated water to the raw oil, in order to remove the hydratable phosphatides, commonly known as “gums”. Next, the hydrated gums are separated in centrifuges, and the degummed oil is dried.

The next step is neutralization, where the degummed oil is heated and has the addition of phosphoric acid and a sodium hydroxide diluted solution. The phosphoric acid precipitates the non hydratable gums, which were not removed in the degumming process, and the sodium hydroxide reacts with the free fatty acids present in the oil. The production of these chemical reactions is called “sludge”, and is removed from the oil by means of separation in centrifuges.

The neutral oil is then mixed again with heated water, and next submitted to the separation in centrifuge, for removing the soaps formed during neutralization. After the washing step, the neutral oil is dried while the washing water is directed to the effluent treatment.

The following step, as called whitening, which consists of adding specially activated clays to the oil, which object is to eliminate some pigments present in the oil. After a certain time of contact with the activated clays, the oil is filtered for removing thereof, thus obtaining the clarified oil.

Finally, in the deodorization stage the oil is heated under vacuum, undergoing a distillation process, where compounds which cause an unpleasant odor and taste to it as well as some pigments and free fatty acids are removed. After this stage the product has the addition of an antioxidant, generally citric acid, which also acts as a sequestrant of metals, which can unleash the oil oxidation process.

For the addition of Q10 coenzyme it is recommended that the oil is previously heated to a temperature in the range of 40-50° C. and then, the Q10 coenzyme is added to the vegetal oil or to the mixture of oils. The system is mixed, preferably for about 10-15 minutes for its total homogenization.

After incorporating Co10, E vitamin and/or the mix of tocopherols can be directly added to the product. The product has then the addition of an inert gas, commonly nitrogen, to minimize the synergic effect between Oxygen/Light/Chlorophyll, forming what we call “head space”, following to bottling, with the temperature varying from 10 to 40° C., depending on the type of package used. Generally the following is used: PET bottle, can, drum, big pumps, and it can also be sold in bulk.

The product obtained at the end is a product with characteristics color and flavor, with a clean and shiny aspect, free of suspending or precipitated particles.

The oils or mixture of oils, object of this invention, can also have the addition of liposoluble vitamins (as, for example, A, D and K vitamins), minerals (such as selenium, zinc, iron, etc.) as even essential fatty acids, such as omega 3 and omega 6, from the use of fish oil. They can also be flavored by several types of spices, in the form of seeds, leaves, branches, bulbs, grains, etc., providing them with characteristic odor and flavor.

It has been found that in the case of vegetal oils, or the mixture of oils of two or more types, being either of vegetal or animal origin, the action of Q10 coenzyme and E vitamin in inhibiting or delaying the reaction of lipidic oxidation, increasing the useful life time of the product by at least 2 months, depending on the type of package used for bottling: bulk, can, drum, PET bottle, etc.

In order that this invention is better understood it will be illustrated by the following examples, which are not intended to limit the invention.

### Example 1

A food grade vegetal oil already deodorized was taken—in this example, soy oil, with the addition of antioxidant and antifoamer.

| | |
|---|---|
| Deodorized vegetal oil | 99.975% |
| Rosemary extract | 0.02% |
| Citric acid | 0.005% |

First the oil was heated to a temperature in the range of 40-50° C. in order to make the homogenization easy. Q10 coenzyme was incorporated to the oil, in concentrations in the range of 0.01 to 5% by weight. Next, the system was mixed, preferably around 10-15 minutes in order to guarantee full incorporation.

After Co10 was incorporated, E vitamin was added directly to the product in a quantity in the range of 0.001 to 1% by weight, in relation to the total weight of the product. The oil then had the addition of nitrogen, as previously explained. After adding nitrogen, the product was bottled in PET bottle with a temperature ranging from 16 to 20° C.

With the aim of “accelerating” the lipidic reaction, the products (control and test) underwent the same storing conditions, exposed to the light, in room temperature and spent 5-6 hours daily in a greenhouse at 40° C. The antioxidant performance of the E vitamin and/or the mix of tocopherols combined with the Q10 coenzyme, was evaluated comparatively to the same production without the action of the E vitamin and/or the mix of tocopherols and the Q10 coenzyme, the latter being called “control sample”.

The samples—Control and Example 1—were analyzed both weekly and bi-weekly during 3 months, where the following measurements were carried out:
a. peroxide index: which determines the primary oxidation compounds—peroxides and hydroperoxides—measuring the quantity of oxygen associated to such transformation; the higher the peroxide index, the higher the oxidation grade of the product;
b. Anisidine index: which determines the secondary oxidation compounds (saturated and unsaturated aldehydes) from the decomposition of peroxides and hydroperoxides; it is “favored” by temperature and absence of oxygen, it is very important when monitoring the frying process;
c. Acidity: which results of the hydrolysis process of triglycerides, it is a measurement of the degradation grade of oils and fats;
d. Sensory evaluation: carried out by trained examiners who evaluate and determine the attributes of the oil and detect the presence or absence of signs of rancid and oxidates, gramineous, fatty acid and other signs characteristics of the lipidic oxidation reaction.

With the results obtained it was possible to make a projection for the normal storage conditions, extrapolating the total useful life time using Q10 of the oil equal to 4.

Q10 is a parameter which expresses the quotient of the speed of a reaction transformation and useful life, in function of the storage temperature, that is, in increment of +10° C. For example: if Q10 of the oil is 4 and the same was evaluated for 3 months at 35-40° C., we will have a useful life equal to 4×3, that is, 12 months at room temperature (around 25° C.).

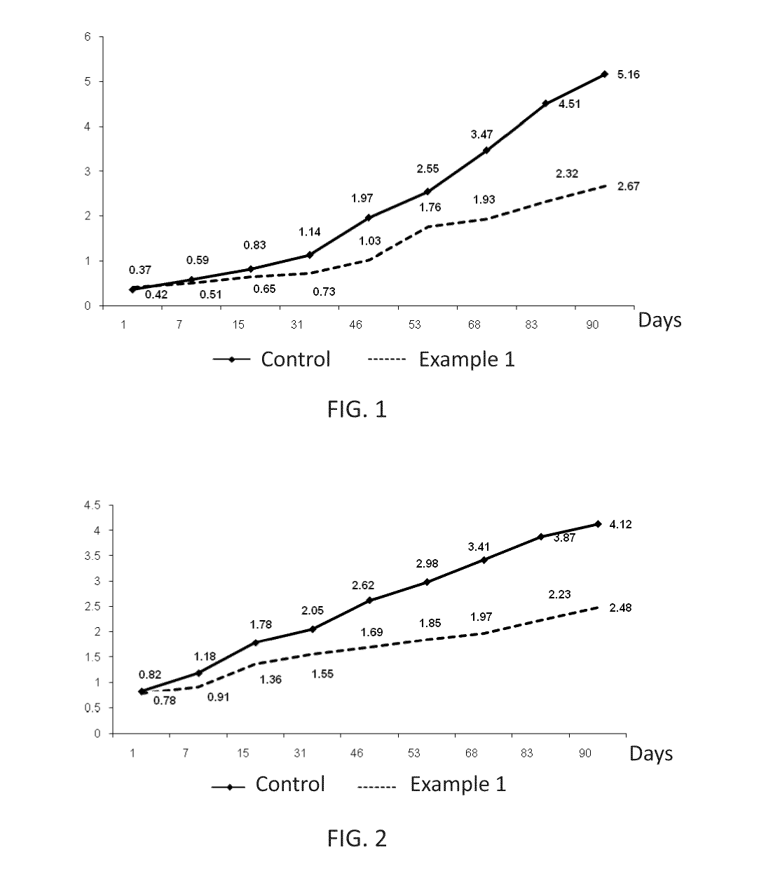

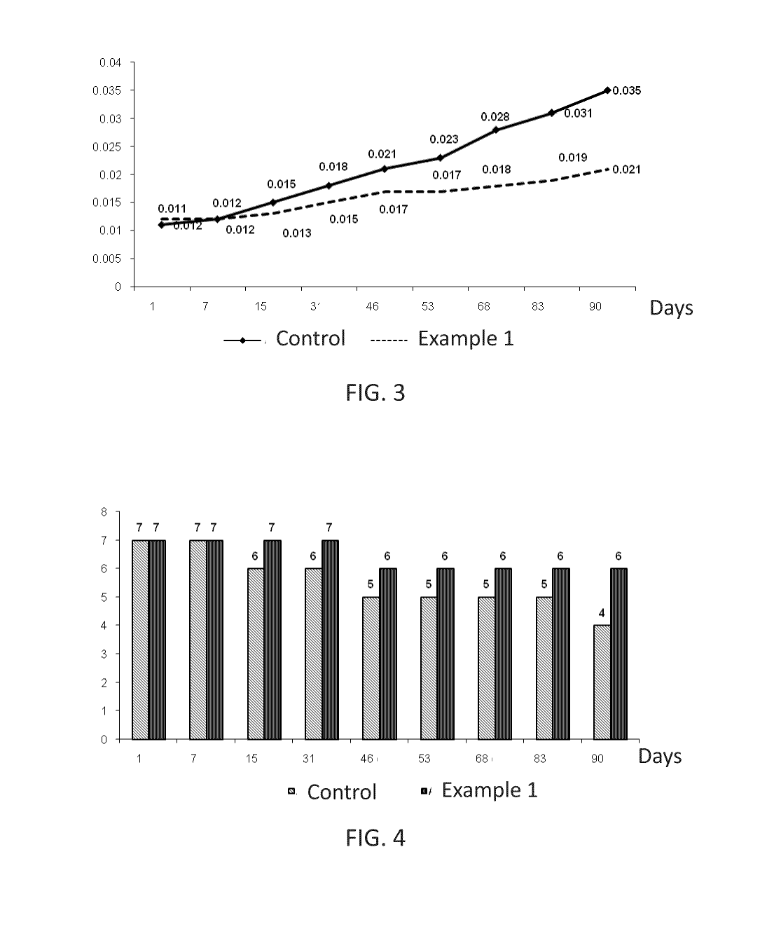

The results obtained during follow up of the useful life of the products are shown on the Figures at the end of the specification, wherein FIG. 1 shows a curve relating to the dosage of the peroxide index (meq/kg), FIG. 2 shows the Anisidine index, FIG. 3 expresses acidity (% oleic acid). p By evaluating the results of the peroxide index, anisidine index and acidity it is concluded that, surprisingly, the samples containing E vitamin and Q10 coenzyme, have the lipidic oxidation reaction delayed in approximately 2 months, in comparison with the Control samples.

Such data were proven by sensory evaluation, carried out weekly and bi-weekly for 3 months, by a trained analyst team, which result is shown on FIG. 4, at the end.

The grades from 7 to 6 mean that the product still has the suitable characteristics, without appearing oxidative signs (gramineous, rancid, fish, etc). The grades from 5 to 1 refers to the appearance of oxidative signs, which are undesirable signs such as rancid, metallic, oxidated, fish, graminio signs, and cause rejection of the products by the consumers, as well as alteration of the nutritional composition of the food.

### Example 2

In this example it was taken a mixture of oils of two or more types, being either of vegetal or animal origin, food grade, such as: soy or canola or sunflower or corn or rice or grape seed and fish oil. In this case there were used soy, sunflower, canola and fish oil, in the concentration of 0.01 to 5% by weight.

The oil was previously heated at a temperature of 40-50° C. and the Q10 coenzyme was incorporated to the mixture of oils (a mixture of soy, sunflower, canola and fish oil, in the concentration of 0.01 to 5% by weight), in order to make its homogenization easy. Next, the system was mixed preferably for around 10-15 minutes in order to guarantee full incorporation of the coenzyme.

| | |
|---|---|
| Mixture of two or more types of oil of | 99.955% |
| vegetal and/or animal origin, | |
| of triglyceridic nature | |
| Rosemary extract | 0.01% |
| Tocopherol mix | 0.03% |
| Citric acid | 0.005% |

After incorporating Co10, the E vitamin was added directly to the product in a quantity of 0.001 to 1% by weight, relating the total weight of the product. The oil had then the addition of nitrogen, in order to minimize the synergic effect between Oxygen/Light/chlorophyll, forming what is called “head space”, as already mentioned previously. After adding nitrogen, the product was bottled in PET bottles and with a temperature ranging from 16 to 20° C.

The products (control and test) underwent the same storage conditions, exposed to light, at room temperature and stayed 5-6 hours daily in a greenhouse at 40° C.

Thus, it was possible to “accelerate” the lipidic reaction, and evaluate the antioxidant performance of the E vitamin combined with the Q10 coenzyme, comparing the results with the control sample (same product without the action of the E vitamin and Q10 coenzyme).

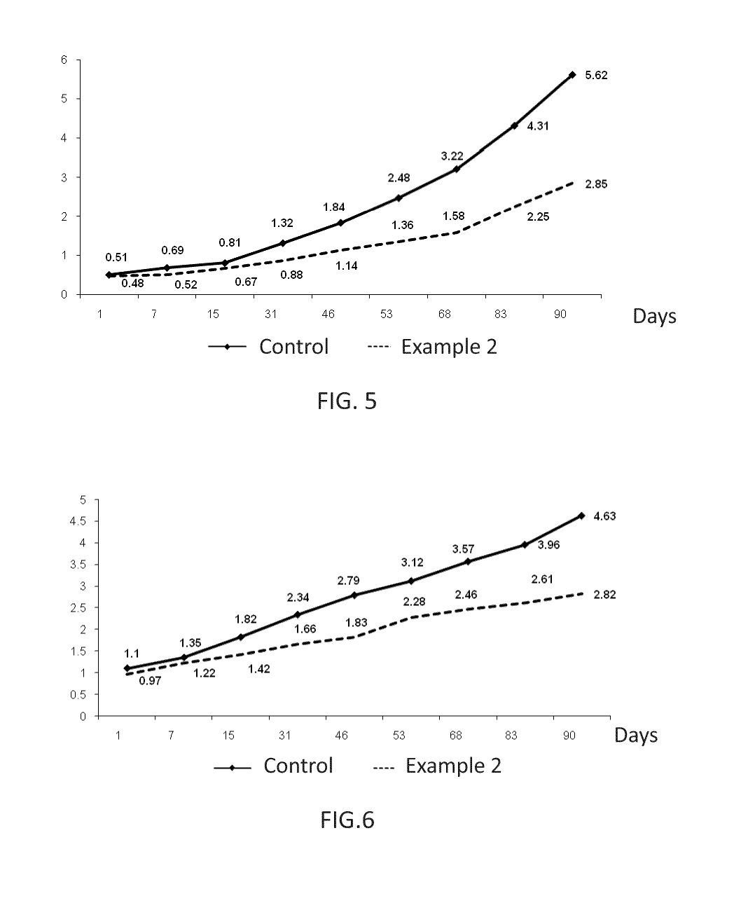

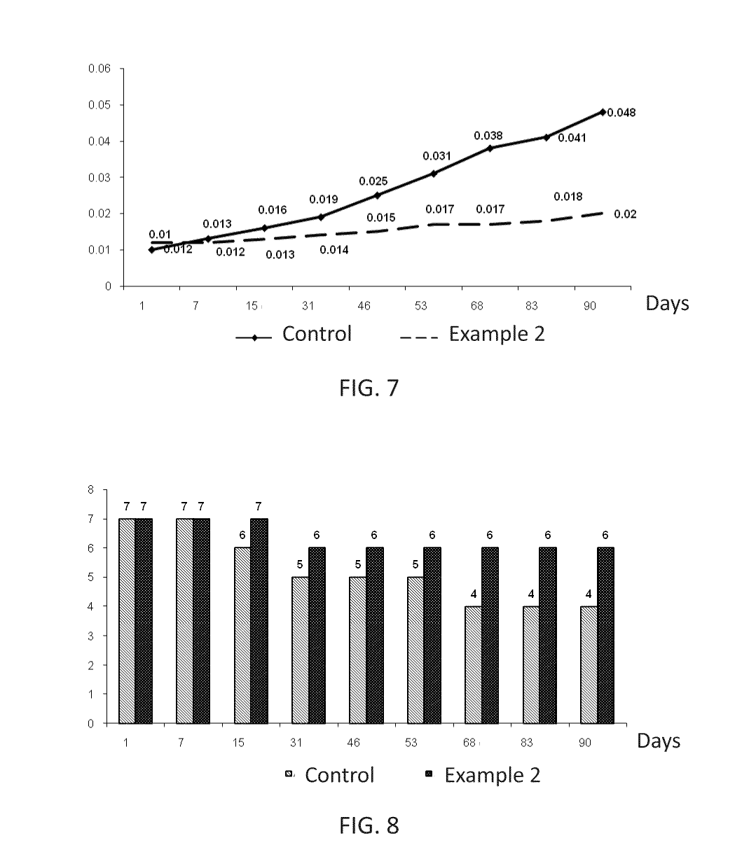

All the samples were analyzed weekly and bi-weekly, during 3 months, in order to determine the peroxide, anisidine, and acidity indexes, as well as the sensory analysis tests. The results are shown on FIGS. 5 to 8 at the end of the specification.

With the results obtained it was possible to make a project for the normal storage conditions, extrapolating the total useful life time, using Q10 of the oil equal to 4.

As already explained previously, Q10 is a parameter which expresses the quotient of speed of a transformation of reaction and useful life, in function of the storage temperature, or with increment of +10° C. For example: if Q10 of the oil is 4 and the same was evaluated for 3 months at 35-40° C., we will have a useful life equal to 4×3, or, 12 months at room temperature (around 25° C.).

Evaluating the results of peroxide index, anisidine index and acidity, it is concluded that the samples with E vitamin and Q10 coenzyme, have the reaction of lipidic oxidation delayed around 2 months, in comparison with the Control samples. The data were proven by sensory evaluation, carried out weekly and bi-weekly, for 3 months, by a trained analyst team. The result is shown on FIG. 8.

As it is can be surprisingly proven the association of the E vitamin with Q10 coenzyme has shown a highly effective antioxidant effect, besides aggregating nutritional value to the product.

This advance in relation to the previous art makes highly advantageous its use in the industry, not only to guarantee longer period of time of storage of the products, but also to the products which use such type of fat based products, since it makes it possible to preserve its quality and characteristics for a longer period.

The foregoing description and accompanying drawings illustrate the principles, preferred embodiments and modes of operation of the invention. More specifically, the encrypted identification systems and methods according to the present invention have been described with respect to an inventory system and process. However, the invention should not be construed as being limited to the particular embodiments discussed above. Additional variations of the embodiments discussed above will be appreciated by those skilled in the art as well as for applications, unrelated to inventory, that require encrypted identification of parts.

The above-described embodiments should be regarded as illustrative rather than restrictive. Accordingly, it should be appreciated that variations to those embodiments can be made by those skilled in the art without departing from the scope of the invention as defined by the following claims.

1. (canceled)

2. (canceled)

3. (canceled)

4. (canceled)

5. (canceled)

6. A composition containing triglyceridic nature oil having improved nutritional properties, comprising at least one food grade oil, of triglyceridic nature, selected from the group consisting of soy, canola, sunflower, corn, rice, grape seed, and combinations of the foregoing and consisting of 0.01% to 5% by weight of coenzyme Q10 in relation to the total weight of the product, and 0.0001% to 1% by weight of E-vitamin E, in relation to the total weight of the product.

7. A composition according to claim 6, further comprising liposoluble vitamins, minerals, and essential fatty acids from the use of fish oil.

8. A composition according to claim 6, further comprising spices of several types, in the form of seeds, leaves, branches, bulbs, and grains.

9. A composition according to claim 7, wherein said liposoluble vitamins are selected from the group consisting of: vitamin A, vitamin D, vitamin K, and combinations of the foregoing.

10. A composition according to claim 7, wherein said minerals are selected from the group consisting of selenium, zinc, iron, and combinations of the foregoing.

11. A composition according to claim 7, wherein said essential fatty acids are selected from the group consisting of: omega 3, omega 6, and combinations of the foregoing.

12. A process for preparing a composition containing trigyceridic nature oil having improved nutritional properties, comprising the steps of:
obtaining a neutral, food grade oil of triglyceridic nature from one or more origins from a sequence of treatments which comprise degumming of a raw oil, neutralization, drying, whitening, and deodorization;
heating the neutral oil obtained in the previous step to a temperature in the range of 40° C. to 50° C.;
adding a quantity of 0.01% to 5% by weight of coenzyme Q10 in relation to the total weight of the product, to the heated oil and mixing for 10 to 15 minutes, in order that homogenization occurs;
adding vitamin E in a quantity in range of 0.001% to 1% by weight in relation to the total weight of the product; and
packing the thus obtained mixture in suitable packages.

13. A process for preparing a composition containing triglyceridic nature oil having improved nutritional properties according to claim 12, wherein the composition thus produced has increased resistance to lipidic oxidation, which increases the useful life of the product by at least 2 months, depending on the type of package used.

14. A composition containing triglyceridic nature oil having improved nutritional properties, comprising a mixture of food grade oils of triglyceridic nature, wherein the food grade oils are either of vegetal or animal oils, and consisting of 0.01% to 5% by weight of coenzyme Q10 in relation to the total weight of the product and 0.0001% to 1% by weight of vitamin E in relation to the total weight of the product.

15. A composition according to claim 14, further comprising liposoluble vitamins, minerals, and essential fatty acids from the use of fish oil.

16. A composition according to claim 14, further comprising spices of several types, in the form of seeds, leaves, branches, bulbs, and grains.

17. A composition according to claim 15, wherein said liposoluble vitamins are selected from the group consisting of: vitamin A, vitamin D, vitamin K, and combinations of the foregoing.

18. A composition according to claim 15, wherein said minerals are selected from the group consisting of: selenium, zinc, iron, and combinations of the foregoing.

19. A composition according to claim 15, wherein said essential fatty acids are selected from the group consisting of: omega 3, omega 6, and combinations of the foregoing.

20. A composition according to claim 12, which further comprising carrying out the adding step by adding a quantity of 0.01% to 5% by weight of coenzyme Q10 in relation to the total weight of the product, to the heated oil and mixing for 10 to 15 minutes, in order that a perfect homogenization occurs.

21. A process for preparing a composition containing trigyceridic nature oil having improved nutritional properties, comprising the steps of:
obtaining a neutral, food grade oil of triglyceridic nature from one or more origins from a sequence of treatments which comprise degumming of a raw oil, neutralization, drying, whitening, and deodorization;
heating the neutral oil obtained in the previous step to a temperature in the range of 40° C. to 50° C.;
adding a quantity of 0.01% to 5% by weight of coenzyme Q10 in relation to the total weight of the product, to the heated oil and mixing for 10 to 15 minutes, in order that homogenization occurs;
adding vitamin E and a mix of tocopherols in a quantity in range of 0.001% to 1% by weight in relation to the total weight of the product; and
packing the thus obtained mixture in suitable packages.

22. A process for preparing a composition containing triglyceridic nature oil having improved nutritional properties according to claim 21, wherein the composition thus produced has increased resistance to lipidic oxidation, which increases the useful life of the product by at least 2 months, depending on the type of package used.

23. A composition according to claim 21, which further comprising carrying out the adding step by adding a quantity of 0.01% to 5% by weight of coenzyme Q10 in relation to the total weight of the product, to the heated oil and mixing for 10 to 15 minutes, in order that a perfect homogenization occurs.
